(19) United States
(12) Patent Application Publication
(10) Pub. No.: US 2003/0200875 A1
(43) Pub. Date: Oct. 30, 2003

(54) Ground meat separator

(76) Inventor: Barbara Mae Chatfield, New Bloomington, OH (US)

Correspondence Address: Barbara Mae Chatfield, Morris, P.O. Box 17, New Bloomington, OH, 43341, US

(21) Appl. No.: 10/403,256

(22) Filed: Apr. 1, 2003

Related U.S. Application Data
(60) Provisional application No. 60/374,633, filed on Apr. 24, 2002.

(51) Int. Cl. A23N 1/00

(52) U.S. Cl. 99/495

(57) ABSTRACT

The ground meat separator is manually usable. It comprises of a blade assembly and a handle which are secured together with supports located on two opposite sides for improving mobility with its structure. The ground meat separator comprises of a heat shield located between the blade assembly and handle to prevent burns. The side supports means a specific space between the handle, heat shield, and the blade assembly. The blade assembly includes two sets of two blades that criss-cross with one another perpendicularly with an octagonal shaped frame holding all the blades in a specific placement.

Applicant claims priority of Provisional Application of serial No. 60/374,633 with the filing date of Apr. 24, 2002

### BACKGROUND OF THE INVENTION

1. Field of the Invention

In the home cooking field it is known to use various types of potato smashers to cut up potatoes or meat dicers, etc. to dice up meat into tiny bits while the meat is being cooked. The present invention relates to a device for separating or breaking up meat into smaller pieces during the cooking process.

2. Description of the Related Art

Reference is now made to US patents are U.S. Pat. Nos. 50,724, 171,603, and 3,352,340. These types of inventions are used for smashing potatoes or to dice the potatoes into uniform pieces for salads. These inventions are also used on the vegetables after the cooking process has been finished. These devices cannot be used during the cooking process at any time.

One other invention is the food dicer, reference to U.S. Pat. No. 3,349,824. This invention is made up of a mesh of crisscrossing wires with a horizontal handle mounted on the top of it. These wires are designed to dice food when using a downward motion. This particular device is used to dice potatoes into uniform pieces for potato salad.

### OBJECTS AND ADVANTAGES

The previous types of devices are applied by using a downward force repeatedly with one's hand by depressing the handles to smash the potatoes into a pulpy mass. They also have blunt edges in order to pulverize the potatoes into a smooth texture. The new invention has a handle on it located in a horizontal position for more stability. The previous devices do not have the same type of handle to be used for the same task as the new invention.

The previous devices cannot be used during the cooking process of any type of food, because they do not contain a heat shield to prevent the steam from scalding one's hand during usage. The cutting edges on these devices do not have sharp enough edges to cut the meat into small bits. The sharp cutting edges on the new invention are necessary for separating the ground meat. The design of the previous devices cannot be used in a hot skillet because of the lack of stability and heat shield. The heat shield is used to guard one's hand from the steam that rises from skillet while the meat is cooking. It is necessary for the heat shield to be present so that one's hand is not scalded during usage.

The plastic around the outside of the blade assembly keeps the blades from scratching any of the surfaces of the pan during usage. The blades are not quite flush with the bottom of the plastic frame so that it prevents damage to the skillet. The plastic surrounding the blades also holds the blades in place and keeps them spaced evenly apart at all times so the meat does not clog up the cutting edges. The type of plastic that this whole utensil is made out of is heat resistant so it can be used inside a heated skillet without any damage and to extend the life of the utensil which makes it safer to use.

The cutting edges and their shape aid in the process of breaking the ground meat into smaller bits and prevents the meat from getting clogged in between the blades because the meat would be difficult to work with if it gets clogged up in between the blades. The location of these blades is very important because of this factor. These multiple blades also cut down on the amount of time spent to break up the ground meat. There are several cutting edges on the new invention compared to the one cutting edge on a wooden spoon or plastic spatula. Since these cutting edges cut the larger bits up into smaller, more proportionate bits, this allows the meat to be cooked completely and thoroughly. This prevents the chances of harmful bacteria to exist once the cooking process is finished.

The new invention is molded out of plastic made into one piece with the blades molded into place for more durability and stability, and for easier clean up and storage.

### BRIEF DESCRIPTION OF THE DRAWINGS

In the drawings, the figures show different views, aspects, functions, and desired embodiments of the present invention, wherein:

FIG. 1 is a top view showing the meat separator handle, heat shield and outer support edge for the blade assembly.

FIG. 2 is a front view of the meat separator showing the handle, heat shield, and outer support edge of the blade assembly.

FIG. 3 is a bottom view of the blade assembly showing the outer support edges.

FIG. 4 is a view of one of the blades as seen from arrow 4 in FIG. 3.

FIG. 5 is a cross sectional view as seen through line 5-5 of FIG. 4.

FIG. 6 is a view of an alternate embodiment of the blade.

### DESCRIPTION OF THE PREFERRED EMBODIMENT

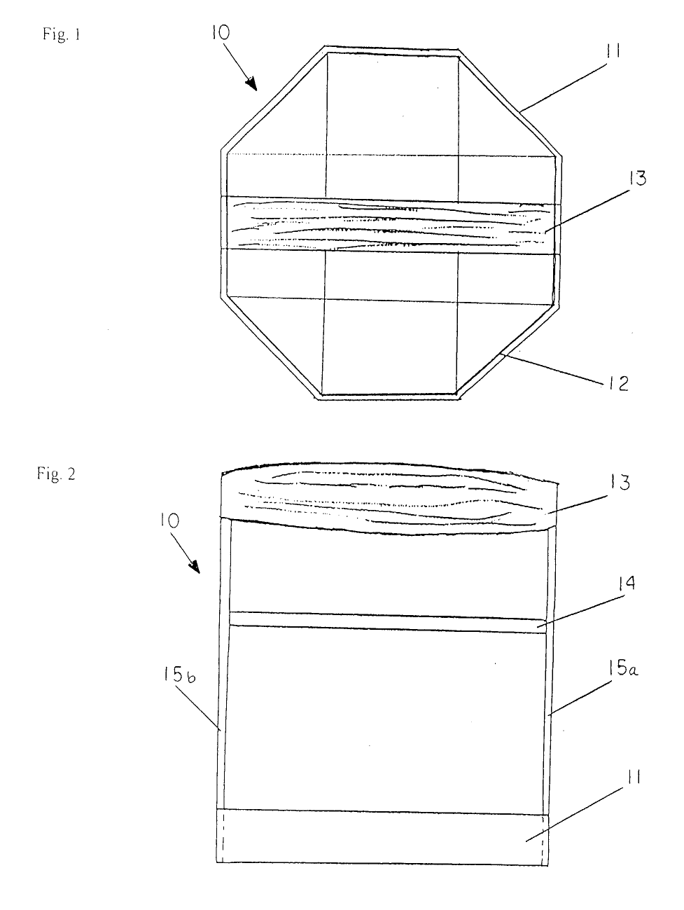

With reference to FIG. 1 a preferred embodiment of the meat separator 10 according to the present invention is illustrated. The outer edge support 11 for the blade assembly and handle 13 can be seen in FIG. 1.

In particular, with reference to FIG. 2, the top portion of the separator includes a handle 13 which is attached at each of its outer ends to side members 15a, 15b. There below a heat shield 14 is attached at each of its outer ends to side members 15a, 15b. The bottom portion of the separator includes a blade assembly 11 attached at each of its outer ends to side members 15a, 15b.

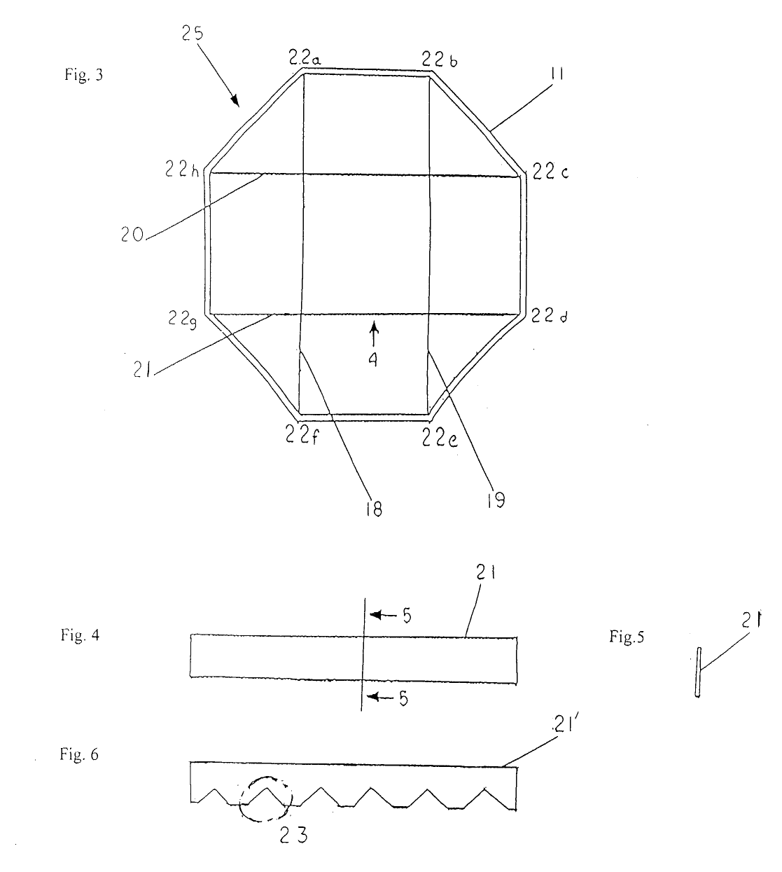

With reference to FIG. 3, the blade assembly 25 is generally shown with a hexagonal shaped outer edge support 11 containing eight angled corners 22a, 22b, 22c, 22d, 22e, 22f, 22g, and 22h. Blades 18, 19 run parallel to each other and attach at each of its outer ends to upper and lower corners 22a, 22b, 22f and 22e. Blades 20, 21 run parallel to each other and attach at each of its outer ends to side corners 22c, 22d, 22g and 22h. Blades 18, 19 run in a perpendicular relationship with blades 20, 21.

With reference to FIG. 4, blade 21 shows the typical type of blade needed to accomplish the task of breaking up the meat. A plurality of rectangular shaped blades would be needed to complete the device.

With reference to FIG. 6, blade 21′ shows an alternate embodiment of the blade needed to accomplish the task of breaking up certain types of meats. At the lower edge of the blade a plurality of triangular shaped cut-outs 23 can be found.

I claim:

1. A ground meat separator comprised of a blade assembly.

2. The blade assembly of claim 1 is comprised of a plurality of two sets of two metal blades in in a criss-crossed perpendicular pattern.

3. The blade assembly of claim 1 is comprised of two criss-crossed sets of blades held together with an octagonal shaped frame.

4. The blade assembly of claim 1 comprises two side supports on either side whereas said to connect with a plate known as a heat shield.

5. The blade assembly of claim 1 comprises of a horizontal handle whereas said to connect with the side supports.

6. The blade assembly of claim 1 whereas said to have a specific distance from the heat shield.

7. The blade assembly of claim 1 whereas said to have a specific distance from the horizontal handle.

8. The blade assembly of claim 1 whereas said to have two supportive sides to add strength to the entire device.

9. The blade assembly of claim 1 is comprised of heat resistant plastic.
